(19) United States
(12) Patent Application Publication
(10) Pub. No.: US 2010/0029275 A1
(43) Pub. Date: Feb. 4, 2010

(54) Migration of TCP connections with layer 2 support in wireless environments

(76) Inventors: Peter Bosch, New Providence, NJ (US); Mauricio Cortes, Scotch Plains, NJ (US); Tom J. Janiszewski, Andover, NJ (US); Jim B. McKie, Murray Hill, NJ (US); Sape J. Mullender, North Plainfield, NJ (US); Ajay Rajkumar, Morristown, NJ (US); Michael C. Recchione, Nutley, NJ (US); David A. Rossetti, Randolph, NJ (US); Michael D. Turner, Madison, NJ (US)

Correspondence Address: HARNESS, DICKEY & PIERCE, P.L.C., P.O. BOX 8910, RESTON, VA, 20195, US

(21) Appl. No.: 12/219,988

(22) Filed: Jul. 31, 2008

(51) Int. Cl. H04W 36/00

(52) U.S. Cl. 455/436

(57) ABSTRACT

Example embodiments provide methods of transparently migrating a reliable transport layer connection between a user and a first base station and a second base station in a wireless network. The method includes receiving at least one transport layer connection state information parameter from the first base station at the second base station. The second base station then determines at least one new transport layer connection parameter based on the at least one transferred transport layer connection state information parameter and at least one network condition at the second base station.

### BACKGROUND

There are various well known ways to send data between wireless network components. For example, as shown in FIGS. 1 and 2, in a user's home network, a user 110 may receive data from the user's home agent 170 via mobile IP and the home agent 170 may obtain the requested data from content servers 180 within the home network. The home network may include, portable computer devices 100, mobile phones 110, base stations 120, routers 130, 1xEV-DO controllers (Radio Network Controllers (RNCs)) 140, Packet Data Serving Nodes (PDSNs) (including foreign agents) 150, home agents 170, Authentication and Authorization servers (AAA) 160, and content servers 180. As shown in FIG. 1, mobile IP adds “tunneling” of TCP/IP packets embedded throughout the mobile network, which reappear at the home agent and server ends. FIG. 1 also shows the ability to forward information through different network elements (e.g. controller 140, PDSN 150, etc.) as the users roam around the network. This is accomplished by having mobile IP in the users 100, 110 and home 170 and foreign agents 150 handling the flow of data across the network. Using mobile IP, the user's 100, 110 data session may remain active as the user 100, 110 roams from one network to another, or hands off from one technology to another (e.g. 1xEV to CDMA2000, etc.).

In conventional mobile IP, a user 110 obtains data from a server 180, which may be located within a home network and/or other IP accessible networks. When a user 110 is outside its respective home network and requests data located in server 180, server 180 and a Packet Serving Data Node (PSDN) 150, including a foreign agent, communicate via a transport layer connection. As shown in FIG. 2, the PSDN 250 obtains the requested data and sends the data to the Radio Network Controller (RNC) 240, by for example, Point-Point Protocol (PPP). The RNC 240 then sends the received information to a serving base station 220, by for example, Radio Link Protocol (RLP), which then sends the data to the user 210 over an air interface.

As shown in FIGS. 1 and 2, the various signaling protocols used by different network elements are identified, e.g. Mobile IP, TCP/IP, RLP, etc. As shown in FIG. 2, in conventional data transfer in wireless networks, a transport layer connection is used to retrieve the data from a content server 280 by the PDSN 250. Then the data is sent to the user 210 embedded in other protocols, e.g. RLP, air interface, etc. As the user moves away from one base station and closer to another base station, RNC 240 and PDSN 250 need to keep track of where to send and receive data from the user device 210. This method of retrieving and sending data over the wireless network can cause, for example, high latency, poor energy conservation, and poor handoff efficiency.

### SUMMARY

Further areas of applicability will become apparent from the description provided herein. It should be understood that the description and specific examples are intended for purposes of illustration only and are not intended to limit the scope of the present disclosure.

Example embodiments provide methods of transparently migrating a reliable transport layer connection between a user and a first base station and a second base station in a wireless network. The method includes receiving at least one transport layer connection state information parameter from the first base station at the second base station. The second base station then determines at least one new transport layer connection parameter based on the at least one transferred transport layer connection state information parameter and at least one network condition at the second base station.

Example embodiments also provide receiving a last-byte indicator from a user at the first base station, the last-byte indicator indicating the last byte the user has received. The first base station then sends to the second base station at least one reliable transport layer connection state information parameter.

Example embodiments further provide a method for continuous data streaming to a user, including establishing a transport layer connection between a user and a base station. The base station receives a request for data using a transport layer connection and the base station sends at least a portion of the requested data to the user. The transport layer connection is then transparently migrated to a target base station by transferring at least one transport layer connection state information parameter from the base station to the target base station. At the target base station, at least one new transport layer connection parameter is determined based on the at least one transferred transport layer connection state information parameter and at least one network condition. The data transfer to the user is then continued from the target base station without the user perceiving an interruption in service.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 illustrates various known protocol stacks used in wireless networks;

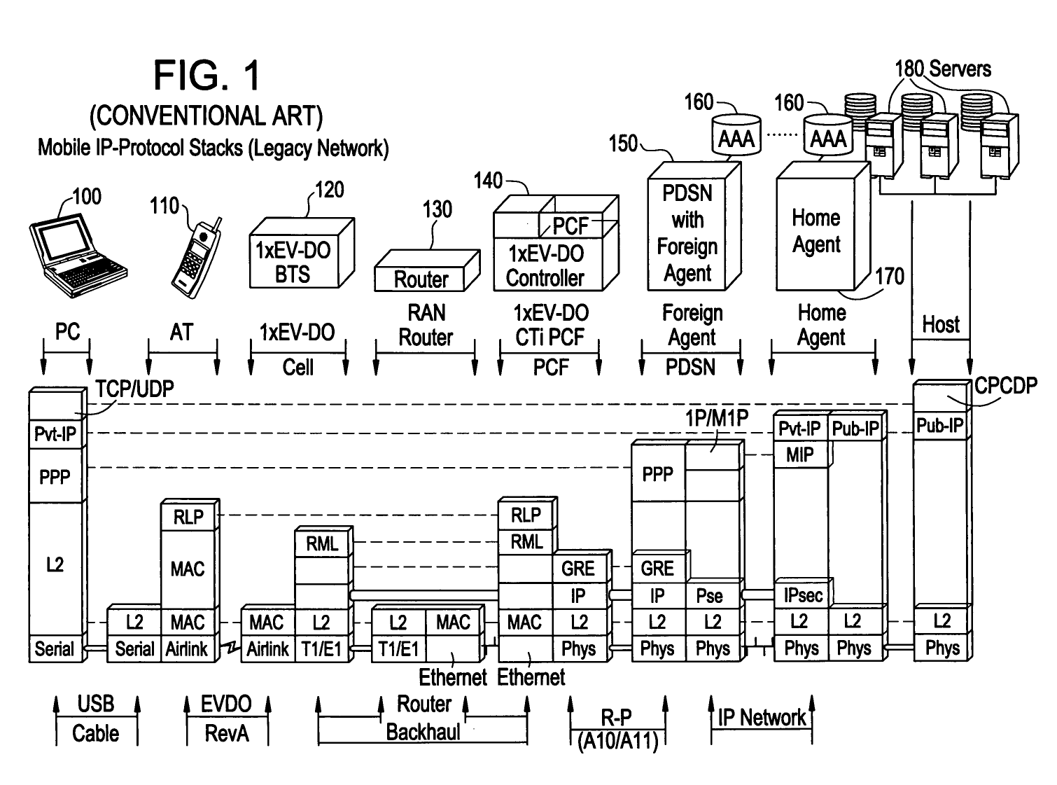

FIG. 2 illustrates a conventional method of transferring data to a user in a wireless network and the corresponding protocols used;

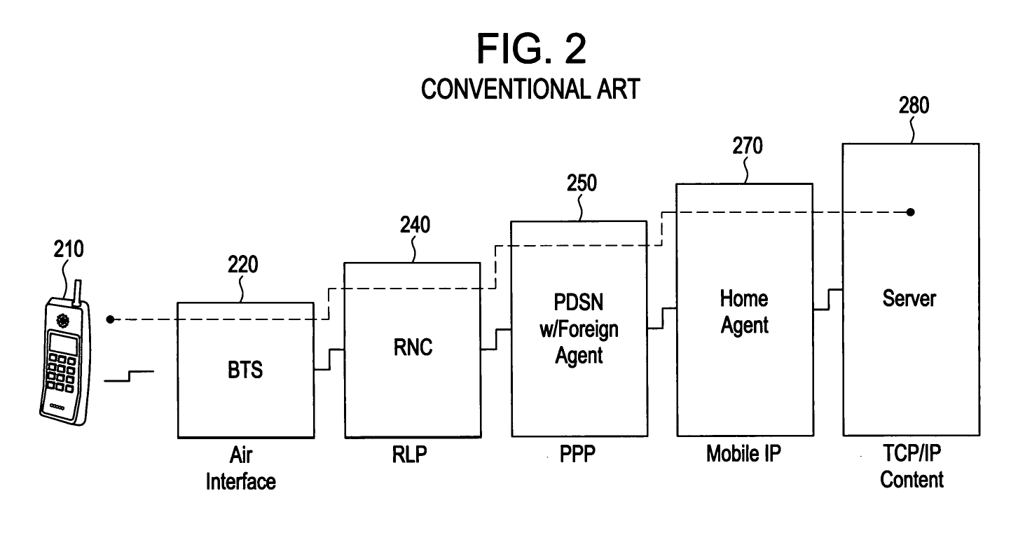

FIG. 3 illustrates a simplified transport layer connection between the user and the base station according to example embodiments;

FIG. 4 illustrates a method of migrating a transport layer connection between two base stations according to example embodiments;

FIG. 5 illustrates a method of migrating a transport layer connection between two base stations where the content server is reached by using a proxy server, according to example embodiments; and

FIG. 6 is a message flow diagram illustrating the migration of a TCP connection during an HTTP transfer according to example embodiments.

### DETAILED DESCRIPTION

Various example embodiments will now be described more fully with reference to the accompanying drawings in which some example embodiments are illustrated. In the drawings, the thicknesses of layers and regions may be exaggerated for clarity.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, e.g., “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the present invention and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements or control nodes (e.g., a scheduler located at a base station or Node B). Such existing hardware may include one or more digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

As used below the terms base station, base transceiver station (BTS) and NodeB are synonymous and may be used interchangeably to describe equipment that provides data connectivity between a wireless network and one or more UEs. Additionally where used below, the terms user, user equipment (UE), subscriber, mobile station and remote station are synonymous and may be used interchangeably to describe a remote user of wireless resources in a wireless communication network.

Example embodiments are directed to migrating a transport layer connection between a user and a first base station to a second base station when wireless network conditions indicate that the user would be better served by the second base station The network conditions may include, for example, signal strength, spare bandwidth, retransmission/error rates, etc. The transport layer connection may be migrated from the first base station to the second base station using a simplified transport layer stack.

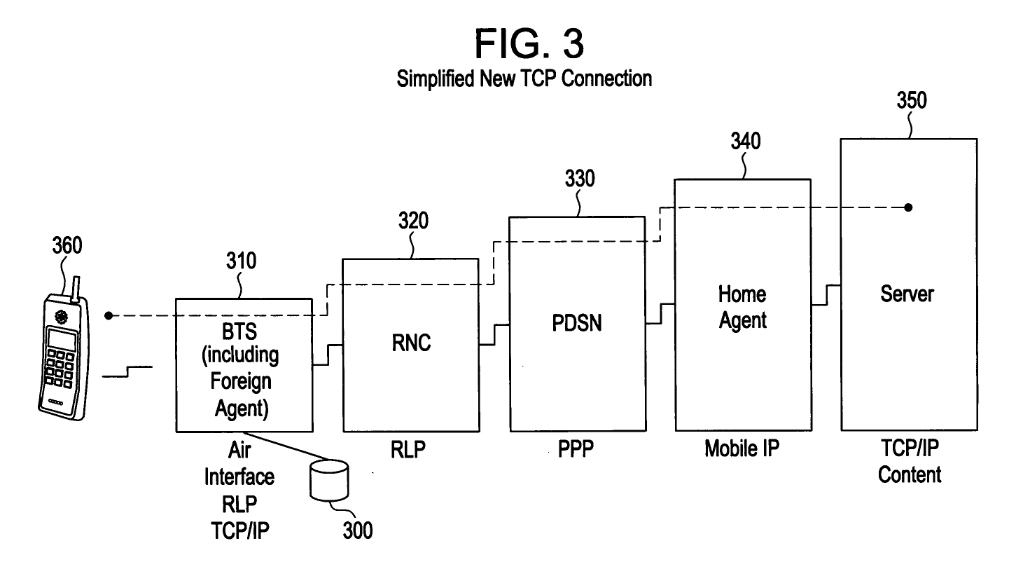

FIG. 3 illustrates a wireless network according to example embodiments. The wireless network may include content servers 350, home agents 340, PDSNs 330, RNCs 320, base stations 310, and users 360. As shown in FIG. 3, connections between a content server 350 and a base station 310 and the base station 310 and a user 360 are illustrated. In FIG. 3, a content server 300 may be located with base station 310, thereby allowing the content to be served locally instead of requiring retrieval from deep in the network.

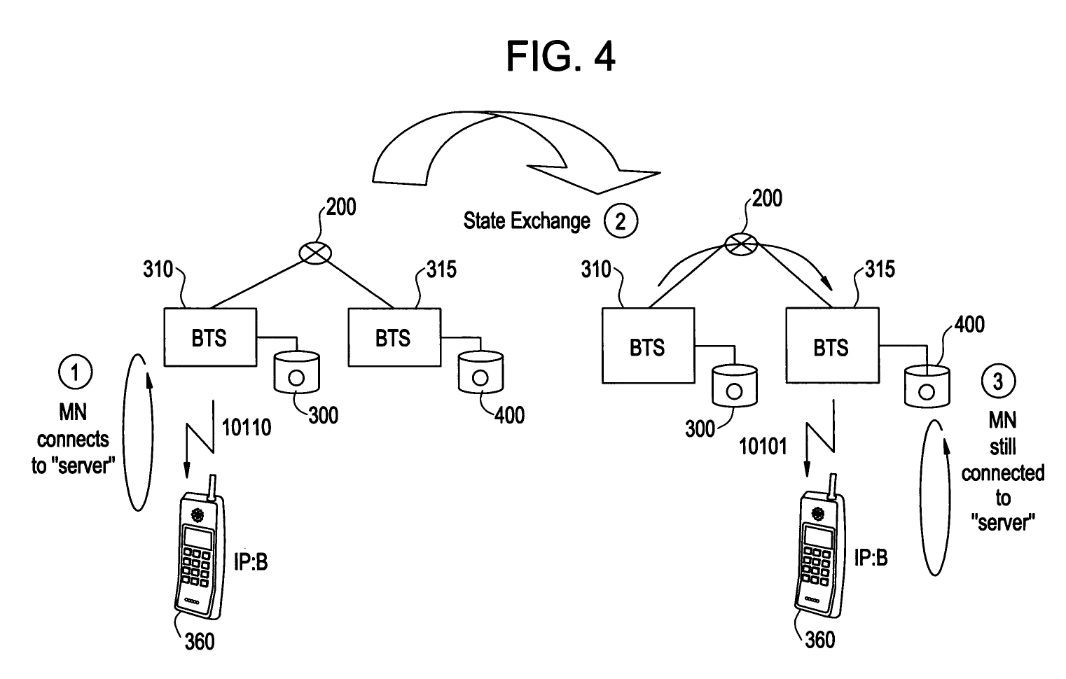

FIG. 4 illustrates a migration of a transport connection between base station 310 and user 360 to base station 315. Example embodiments will be described using Transmission Control Protocol (TCP), however any other transport protocol may be used, for example, Stream Control Transmission Protocol (SCTP), etc. In FIG. 4, user 360 receives content from local content server 300, which may be part of base station 310. Initially, the user 360 connects to server 300 of base station 310 in order to receive user requested content. When radio conditions within the network, for example, signal strength, etc., indicate that user 360 would be better served by base station 315, RNC 320 (FIG. 3) triggers a transport layer connection migration and/or handoff. In example embodiments, determination of whether migration and/or handoff is appropriate may be determined by the user 360, which then notifies the RNC 320. RNC 320 then notifies base station 310 to handoff the user 360 to target base station 315.

According to example embodiments, when a handoff is triggered, base station 310 sends base station 315 at least one transport layer connection state information parameter. The transport layer connection state information parameters will include connection parameters and may include adjustable network parameters. Examples of connection parameters may include, user device address, user device port, base station address, base station port, sequence number, acknowledgment number received by user device, original base station receiving window size, user device receiving window size, transmission timer, etc. Examples of adjustable network parameters may include various network parameters that have been changed from a default value, for example, TCP_MAXSEG (the maximum size of TCP data), TCP_NODELAY (send data immediately), SO_SNDBUF (send socket buffer size), SO_RCVBUF (receive socket buffer size), etc. In example embodiments, all base stations may share the same IP address. If there is a common IP address to all base stations, then the connection parameter (e.g. base station IP address) does not need to be exchanged.

In example embodiments, all or a portion of the above transport layer connection state information parameters may be sent to base station 315 from base station 310. Once base station 315 receives the connection state information parameters, base station 315 may determine zero or more network parameters based on the network condition at base station 315. The network conditions may include, for example, the number of retransmissions of connections migrated from base station 310, signal strength as reported by user station 360, and available downlink bandwidth capacity in base station 315. Base station 315 may determine the new transport layer connection parameters using this Layer 2 information. For example, base station 315 can keep a running average of the number of retransmissions for connections migrated from each neighboring base station, including base station 310. Base station 315 can reduce the transmission window size if this average drops below a τ threshold.

If base station 315 determines at least one advantageous new transport layer connection parameter, the connection parameters will reduce the negative impact of the connection migration. For example, the connection parameters may include base station's 315 transmission window size, retransmission timer based on the received state information parameters, and the network conditions at base station 315. By base station 315 setting at least one of the new transport layer connection state information parameters from base station 310, base station 315 may avoid using the well-known slow-start algorithm and therefore reduce the impact on the throughput to user 360. As is known, the slow-start algorithm is used where the sender increases the amount of outstanding data, possibly introducing additional delay.

The resulting handoff of user 360 to base station 315 is transparent with regard to the user equipment network stacks and data flow. Therefore, user 360 continues to receive the requested data from base station 315 following handoff.

The transport layer connection migration may also include sending buffered content stored in local server 300 of base station 310 to local server 400 of base station 320. Alternatively, base station 310 may not send the buffered content to base station 315 if base station 310 is aware that base station 315 stores the same content in local server 400. In the instance where the buffered content is not sent to base station 315, the time to continue sending data to the user equipment 360 may be further reduced.

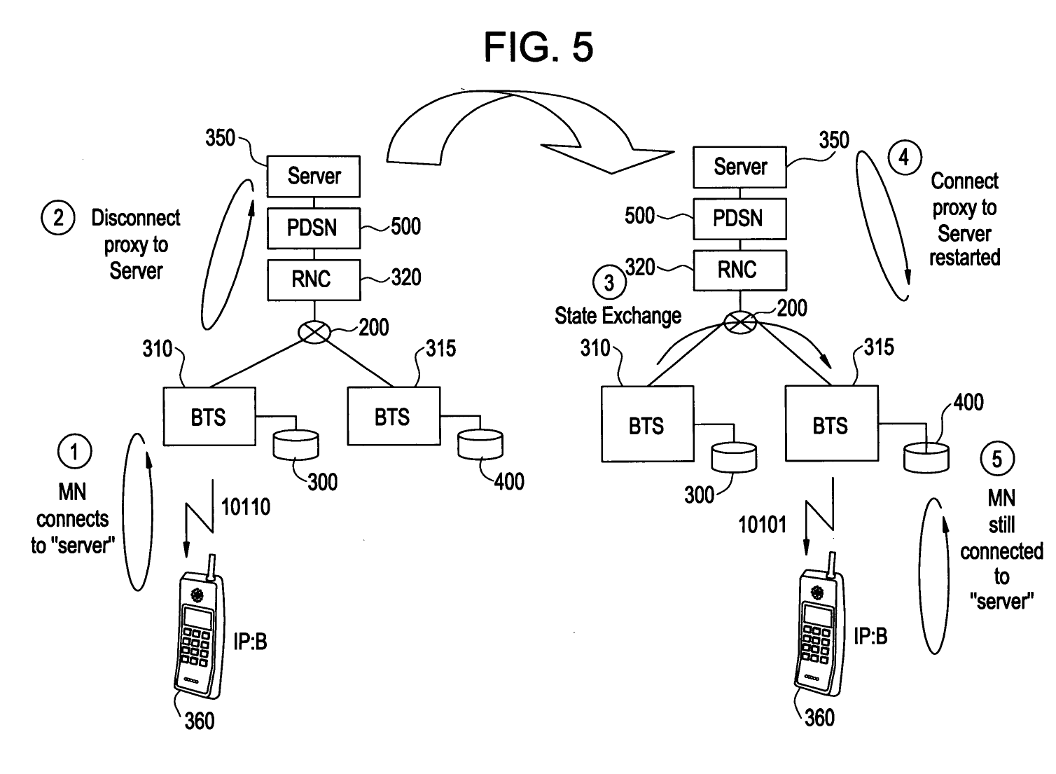

FIG. 5 illustrates a similar method to the one described with reference to FIG. 4, however, in FIG. 5, there is a universal and/or common content server 350, which stores the content requested by user 360. The method to migrate the transport layer connection is similar to the one described above, but in this example embodiment, base station 310 and 315 establish transport layer connections to server 350 in order to download the user requested content to local servers 300 and 400 respectively. The local servers 300 and 400 may act as proxy servers in this example embodiment.

In FIG. 5, user 360 receives content from local content server 300, which may be part of base station 310. Initially, the user 360 connects to server 300 of base station 310 in order to receive user requested content. However, if local server 300 of base station 310 does not have the requested data, then a TCP connection may be established between the base station 310 and content server 350 using proxy servers in order to download the requested data to local server 300. When radio conditions within the network, for example, signal strength, etc., indicate that user 360 would be better served by base station 315, RNC 320 (FIG. 3) triggers a transport layer connection handoff. The determination of whether handoff is appropriate is determined by the user 360, which then notifies the RNC 320. As the handoff message goes through, base station 310 intercepts this message and can start exchanging information with the target base station 315.

According to example embodiments, when a handoff is triggered, base station 310 sends base station 315 at least one transport layer connection state information parameter as described above. Once base station 315 receives the at least one transport layer connection state information parameter, base station 315 may determine zero or more new transport layer connection parameters based on the received at least one transferred transport layer connection state information parameter and at least one network condition at base station 315. Also, base station 315 may determine the new transport layer connection parameters using Layer 2 information from both base station 310 and base station 315 as described above.

Additionally, base station 310 may inform base station 315 that the user requested content was downloaded from content server 350. Depending on whether base station 315 has the user requested content stored in local server 400 or not, base station 315 may connect to content server 350 in order to download the user requested data to local server 400

When base station 315 determines the new transport layer connection parameters, the connection parameters may include base station's 315 receiving window size and retransmission timer based on the received state information parameters and the network conditions at base station 315. By base station 315 re-using at least one of the transport layer connection state information parameters, base station 315 may avoid using the slow start algorithm and decrease the time to re-establish the transport layer connection to the user 360. The resulting handoff of user 360 to base station 315 is transparent with regard to the transport layer connection and data flow. Therefore, user 360 continues to receive the requested data from base station 315 following handoff.

The transport layer connection migration may also include sending buffered content stored in local server 300 of base station 310 to local server 400 of base station 320. Alternatively, base station 310 may not send the buffered content to base station 315 if base station 310 is aware that base station 315 includes the same content in local server 400. In the instance where the buffered content is not sent to base station 315, the time to resume sending data may be further reduced.

In both the example embodiments described with reference to FIGS. 4 and 5, packet loss detected at the radio link layer may not be considered packet congestion. In TCP, packet loss could be caused by packet congestion, which causes the internal TCP stack to reduce the internal congestion window. By reducing the internal congestion window, the TCP connection avoids further congestion. However, the example embodiments described above in a wireless network may treat packet loss as packet loss, not congestion since no intermediate network element is between base station 310 and user device 360. Therefore, if a packet is detected as lost but the signal strength is good, the dropped packet may simply be retransmitted without the internal congestion window having to be reduced.

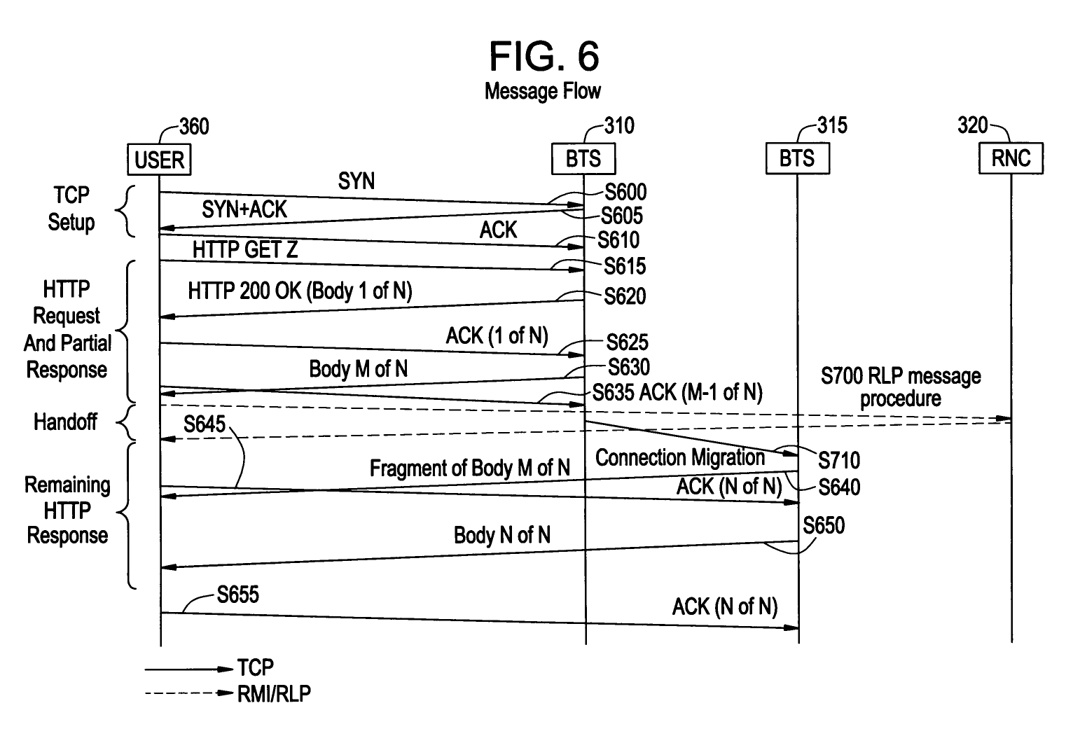

FIG. 6 illustrates an example embodiment of the message flow between a user 360, a serving base station 310, a target base station 315, and RNC 320. Initially, user 360 establishes a TCP connection with base station 310 using a three-way handsake. To establish the TCP connection, user 360 sends a SYN (e.g, TCP synchronize) message to base station 310 in step S600, base station 310 returns a SYN+ACK message in step S605 to the user 360. The user 360 responds with an ACK message in step S610. After setting up the TCP connection, user 360 sends a HTTP GET Z (e.g., an HTTP operation) request to base station 310 in step S615, where Z represents any Universal Resource Locator (URL). In step S620, base station 310 in response sends back a HTTP 200 OK including a first packet of data N. In step S625, user 360 sends back an ACK of the first packet of data N and in step S630, base station 310 sends a portion of the body M of data N.

At a point during step S360 user 360, for example, measures the signal strengths of base station 310 and base station 315 and based in part on these measurements, determines that user 360 would be better served by base station 315. User 360 notifies RNC 320 that a handoff is requested to base station 315 using messaging procedure S700 well known to one skilled in the art. Base station 310 starts the connection migration of user 360 in step S710 as the handoff messaging procedure S700 goes through. User 360 in step S635 sends an acknowledgment of the last data byte received ACK (M-1 of N) to base station 310. Base station 310 transfers state information parameters, including socket information, for example, user port, last sequence acknowledged window size, HTTP command, and range of requested data to base station 315. Base station 315 then creates a new socket, adds the new socket to the TCP table, and notifies the local application of the various connection and data transfer parameters. In addition, once the TCP connection is transferred, base station 310 destroys the existing socket, deletes the socket from the TCP stack, and notifies the local application that the connection has been terminated.

Once the TCP migration is complete, at step S640, base station 315 starts sending the remaining body of M (Fragment of Body M of N) to user 360. User 360 sends ACK (M of N) to base station 315 in step S645 acknowledging receipt. Upon receiving the acknowledgment, base station 315 sends the remaining body N of N to user 360 in step S650 and user 360 acknowledges receipt ACK (N of N) in step S655.

The above described example embodiments provide a reduction in migration delay and improve handoff efficiency. Compared to other base station migration solutions that are not user-transparent, the example embodiments reduce migration delay because the user device and the second base station do not need to reestablish a TCP connection using the expensive three-way handshake. Compared to the conventional art using Mobile IP, the example embodiments decrease migration delay due to two factors. First, the migration between base stations occurs in parallel as the handoff message is processed by the RNC. Second, the migration occurs closer to the user device and not deep into the network. Finally, the example embodiments improve TCP migration efficienciy by not requiring the entire state of the TCP connection to be replicated when a TCP connection is migrated from one base station to another.

Example embodiments of the present invention being thus described, it will be obvious that the same may be varied in many ways. Such variations are not to be regarded as a departure from the spirit and scope of the exemplary embodiments of the invention, and all such modifications as would be obvious to one skilled in the art are intended to be included within the scope of the invention.

What is claimed is:

1. A method of transparently migrating a reliable transport layer connection between a user and a first base station to a second base station in a wireless network, comprising:
receiving at least one transport layer connection state information parameter from the first base station at the second base station; and
determining, at the second base station, at least one new transport layer connection parameter based on the at least one transferred transport layer connection state information parameter and at least one network condition at the second base station.

2. The method of claim 1, wherein the transport layer connection uses at least one of Transmission Control Protocol (TCP) and Stream Control Transmission Protocol (SCTP).

3. The method of claim 1, wherein the at least one transport layer state information parameter includes one of at least connection parameters and adjustable network parameters.

4. The method of claim 3, wherein the adjustable network parameters include at least one network parameter that has been changed from a default value.

5. The method of claim 3, wherein the connection parameters include at least one of, a first base station receiving window size, a user receiving window size, and retransmission timer.

6. The method of claim 1, wherein the determining new transport layer connection parameters step includes,
determining, at the second base station, at least one of receiving window size and retransmission timer.

7. The method of claim 1, wherein the determining step further comprises:
determining new transport layer connection parameters using Layer 2 information, wherein the Layer 2 information includes information from both the first base station and the second base station.

8. The method of claim 1, wherein the transparent connection migration occurs during a user handoff.

9. The method of claim 1, wherein the receiving includes,
receiving at least a portion of buffered content from the first base station at the second base station.

10. The method of claim 1, wherein the receiving includes,
not receiving buffered content from the first base station at the second base station.

11. A method of transparently migrating a reliable transport layer connection between a user and a first base station to a second base station in a wireless network, comprising:
receiving a last-byte indicator at the first base station from the user, indicating the last byte the user has received;
sending from the first base station to the second base station at least one transport layer connection state information parameter and at least one reliable transport layer connection state information parameter indicating the next content byte to be sent to the user.

12. The method of claim 11, further comprising:
receiving a transport layer connection handoff notification at the first base station.

13. The method of claim 11, wherein the sending step further includes,
sending at least a portion of a buffered content to the second base station.

14. The method of claim 11, wherein the sending step does not include sending a buffered content to the second base station.

15. The method of claim 11, wherein the transport layer connection uses at least one of Transmission Control Protocol (TCP) and Stream Control Transmission Protocol (SCTP).

16. The method of claim 11, wherein the at least one transport layer state information parameter includes one of at least connection parameters and adjustable network parameters.

17. The method of claim 16, wherein the adjustable network parameters include at least one network parameter that has been changed from a default value.

18. The method of claim 16, wherein the connection parameters include at least one of, a first base station receiving window size, a user receiving window size, and retransmission timer.

19. A method of continuous data streaming to a user comprising:
establishing a transport layer connection between a user and a base station;
receiving a request for data at the base station, the request using the transport layer connection;
sending at least a portion of the requested data from the base station to the user;
transparently migrating the transport layer connection to a target base station by transferring at least one transport layer connection state information parameter from the base station to the target base station;
determining at the target base station, at least one new transport layer connection parameter based on the at least one transferred transport layer connection state information parameter and at least one network condition; and
continuing the data transfer to the user from the target base station without the user perceiving an interruption in service.

20. The method of claim 19 wherein the migrating step further comprises,
sending at least one reliable transport layer connection state information parameter indicating the next content byte to be sent to the user.
